(19) United States
(12) Patent Application Publication
(10) Pub. No.: US 2017/0153690 A1
(43) Pub. Date: Jun. 1, 2017

(54) METHOD FOR SAVING ENERGY AND ELECTRONIC DEVICE USING THE SAME

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: MING-YI CHEN, Shenzhen (CN); XIAO-YAN ZHANG, Shenzhen (CN)

(21) Appl. No.: 14/983,390

(22) Filed: Dec. 29, 2015

(30) Foreign Application Priority Data
Nov. 30, 2015 (CN) 201510844501.2

(51) Int. Cl. G06F 1/32

(52) U.S. Cl. CPC G06F 1/3262; G06F 1/3203

(57) ABSTRACT

An electronic device includes a control module and a touch panel. The touch panel receives a first signal and a second signal from the control module. The first signal is at a high level when the touch panel is operating normally. When the electronic device enters sleep mode, the control module turns the first signal to be at a low level and records a first operating status of the second signal. The electronic device stops supplying power for the touch panel when the first signal is at a low level; when the electronic device quits sleep mode, the control module adjusts statuses of the first and second signals according to a first sequence. When the first signal is at the high level and the second signal is in the first operating status, the touch panel continues to operate.

### FIELD

The subject matter herein generally relates to a method for saving energy and a device using the same.

### BACKGROUND

A touch panel used in a device will consumes energy when the device is in sleep mode. The touch panel also consumes energy when a screen of the device is locked.

### BRIEF DESCRIPTION OF THE DRAWINGS

Implementations of the present technology will now be described, by way of example only, with reference to the attached figures.

FIG. 1 is a block diagram of an embodiment of an electronic device of the present disclosure.

FIG. 2 is a flow chart of an embodiment of a method for saving energy of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like. The term “operating normally”, means “operating without any faults”.

The disclosure will now be described in relation to an electronic device 100.

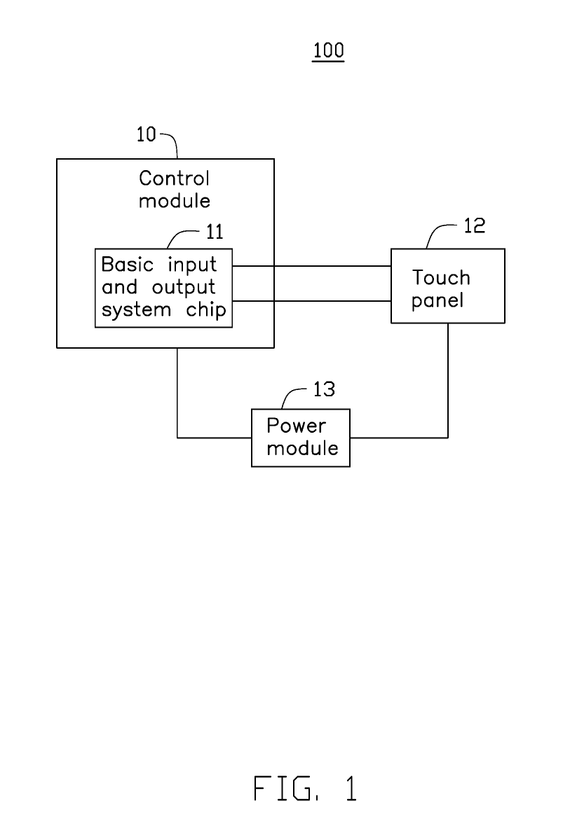

FIG. 1 shows an embodiment of the electronic device 100. The electronic device 100 can comprise a control module 10, a touch panel 12, and a power module 13.

The control module 10 can comprise a basic input and output system chip 11. The basic input and output system chip 11 is used to store a basic input and output system of the electronic device 100. The basic input and output system chip 11 can be encapsulated in a motherboard of the electronic device 100. The basic input and output system chip 11 can be programmed.

The touch panel 12 is coupled to the control module 10. The touch panel 12 is also coupled to the power module 13. The basic input and output system outputs a first signal and a second signal to the touch panel 12. The power module 13 can be a power supply or a part of a power supply. In the illustrated embodiment, the power module 13 is a lithium battery.

When the touch panel is operating normally, the first signal is at a high level, such as logic “1”.

When the electronic device 100 enters a sleep mode, the control module 10 records a first operating status of the second signal and turns the first signal to be at a low level, such as logic “0”. The power module 13 stops supplying power to the touch panel 12 when the first signal is at a low level.

When the electronic device 100 quits the sleep mode, the control module 10 turns the second signal into a high level signal. After a first preset time, the control module 10 turns the first signal into a high level signal. After a second preset time, the control module 10 turns the second signal into a low level signal. After a third preset time, the control module 10 turns the second signal to be in the first operating status. Then the touch panel 12 continues to operate.

In the illustrated embodiment, the electronic is a tablet. There are certain requirements in sequences of the first signal and the second signal.

In other embodiments, the control module can adjust statuses of the first and second signals according to other requirements in sequence.

In the illustrated embodiment, the first preset time is one millisecond. The second preset time is five milliseconds. The third preset time is fifty milliseconds.

In the illustrated embodiment, the first signal is a reboot signal. The reboot signal is used to control the touch panel 12 to reboot. The second signal is an initial signal. The second signal is to control the operating status of the touch panel 12.

The control module 12 further comprises a plurality of general purpose input and output interfaces to control the level of the first and second signals.

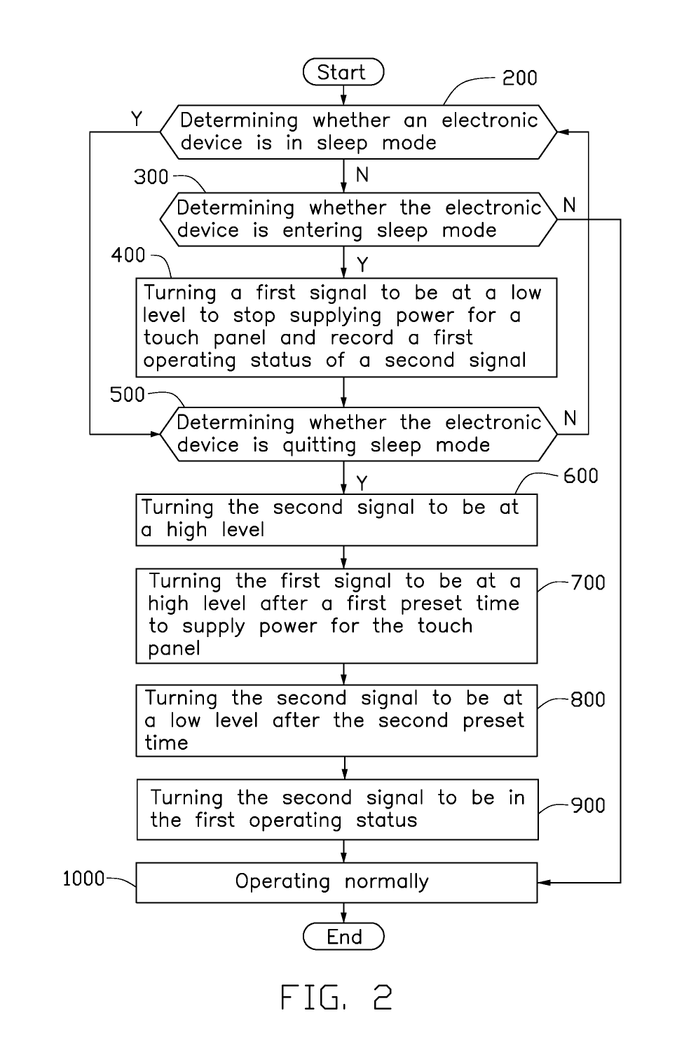

FIG. 2 illustrates a flowchart of a method to save energy. The example method is provided by way of example, as there are a variety of ways to carry out the method. The method described below can be carried out using the configurations illustrated in FIG. 1, for example, and various elements of these figures are referenced in explaining the example method. Each block shown in FIG. 2 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure. The example method can begin at block 200.

At block 200, the control module 10 determines whether the electronic device 100 is in sleep mode. If the electronic device 100 is in sleep mode, the method skips to block 500. If the electronic device 100 is not in sleep mode, the method skips to block 300.

At block 300, the control module 10 determines whether the electronic device 100 is entering sleep mode. If the electronic device 100 is entering sleep mode, the method skips to block 400. If the electronic device 100 is not entering sleep mode, the method skips to block 1000.

At block 400, the control module 10 turns the first signal to be at a low level and records a first operating status of the second signal.

At block 500, Determining whether the electronic device 100 is exiting sleep mode. If the electronic device 100 is quitting sleep mode, the method skips to block 600. If the electronic device 100 is not quitting sleep mode, the method skips to block 200.

At block 600, the control module 10 turns the second signal to be at a high level.

At block 700, the control module 10 turns the first signal to be at a high level after the first preset time.

At block 800, the control module 10 turns the second signal to be at a low level after the second preset time.

At block 900, the control module 10 turns the second signal to be in the first operating status.

At block 1000, the electronic device 100 operates normally.

While the disclosure has been described by way of example and in terms of the embodiment, it is to be understood that the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. An electronic device comprising:
a control module comprising a basic input and output system chip; and
a touch panel coupled to the control module and configured to receive a first signal which is at a high level when the touch panel is operating normally and a second signal from the basic input and output system, wherein the electronic device enters sleep mode, the control module turns the first signal to be at a low level and records a first operating status of the second signal, the electronic device stops supplying power for the touch panel when the first signal is at a low level; and
wherein when the electronic device quits sleep mode, the control module adjusts statuses of the first and second signals according to a first sequence, and once the first signal is at the high level and the second signal is in the first operating status, the touch panel continues to operate normally.

2. The electronic device as claim 1, wherein the control module comprises a basic input and output system chip, the basic input and output system chip stores the basic input and output system.

3. The electronic device as claim 1, further comprising a power module to supply power for the touch panel, wherein when the first signal is at a low level, the power module stops supplying power to the touch panel.

4. The electronic device as claim 1, wherein the first preset sequence is the control module turns the first signal to be at the high level after a first preset time, the control module turns the second signal to be at the low level after a second preset time, the control module turns the second signal to be in the first operating status after a third preset time.

5. The electronic device as claim 4, wherein the first preset time is one millisecond.

6. The electronic device as claim 4, wherein the second preset time is five milliseconds.

7. The electronic device as claim 4, wherein the third preset time is fifty milliseconds.

8. The electronic device as claim 1, wherein the first signal is a reboot signal to control the touch panel to reboot, the second signal is an initial signal to control the operating status of the touch panel.

9. A method for saving energy, comprising:
determining whether an electronic device is in sleep mode;
determining whether the electronic device is entering sleep mode;
turning a first signal to be at a low level to stop supplying power for a touch panel and record a first operating status of a second signal;
determining whether the electronic device is quitting sleep mode;
turning the second signal to be at a high level;
turning the first signal to be at a high level after a first preset time to supply power for the touch panel;
turning the second signal to be at a low level after the second preset time;
turning the second signal to be in the first operating status;
operating normally.
